(19) United States
(12) Patent Application Publication
(10) Pub. No.: US 2022/0389849 A1
(43) Pub. Date: Dec. 8, 2022

(54) MUFFLER VALVE AND MUFFLER

(71) Applicant: SANKEI GIKEN KOGYO CO., LTD., Tokyo (JP)

(72) Inventors: Naoya Kubota, Isesaki-shi (JP); Hidetoshi Sugimoto, Isesaki-shi (JP); Kouji Suzuki, Isesaki-shi (JP); Masaru Noji, Isesaki-shi (JP)

(73) Assignee: SANKEI GIKEN KOGYO CO., LTD., Tokyo (JP)

(21) Appl. No.: 17/776,282

(22) PCT Filed: Nov. 12, 2020
(86) PCT No.: PCT/JP2020/042348

§ 371 Date: May 12, 2022

(30) Foreign Application Priority Data
Dec. 27, 2019 (JP) 2019-238379

(51) Int. Cl. F01N 1/08; F16K 15/03; F16K 47/00

(52) U.S. Cl. CPC F01N 1/08; F16K 15/033; F16K 15/034; F16K 47/012

(57) ABSTRACT

Provided is a muffler valve 1 which is attached to a separator partitioning the inside of a muffler and opens and closes an exhaust passage according to the pressure of an exhaust gas of an engine. A valve body is swingably supported by a support shaft with respect to a valve seat. The valve body is urged in a closing direction by a spring member externally inserted to the support shaft. A valve seat substrate of the valve seat arranged along the separator is formed in a substantially flat-plate ring shape having an opening in the center. A valve body substrate of the valve body is formed in a flat dish shape having a flat rim. The muffler valve provides excellent handleability during attachment and can reduce the manufacturing cost of the muffler, improve manufacturing efficiency, and maintain high durability of the muffler.

### TECHNICAL FIELD

The present invention relates to a muffler valve that is installed in a muffler of an automobile exhaust system and opens and closes an exhaust passage according to the pressure of an exhaust gas of an engine and a muffler having the same.

### BACKGROUND ART

Conventionally, Patent Literature 1 discloses a muffler valve attached to a separator that partitions the inside of the muffler as an example of a muffler valve that is installed in a muffler of an automobile exhaust system and opens and closes an exhaust passage according to the pressure of an exhaust gas of an engine. The first embodiment of Patent Literature 1 describes a valve body support member corresponding to a valve seat and a muffler valve having a valve body. The valve body support member of this muffler valve is provided with a tapered portion and a cylindrical portion extending rearward from an inner peripheral edge of a central hole of the main body, and a wire mesh is fixed to the inner peripheral surface of the tapered portion. The cylindrical portion is fitted to a flange cut up at the opening of the separator. An upright portion that stands up in the direction opposite to the tapered portion is formed on the outer peripheral edge of the main body of the valve body support member, and a pair of stays are formed on both the left and right sides of an upper portion of the upright portion so as to project further from the upright portion.

The valve body is provided with a substantially truncated cone-shaped protrusion near the center, the outer peripheral surface thereof is formed in a shape that overlaps and matches the wire mesh fixed to the tapered portion. An upright portion that stands up in the opposite direction to the protrusion is formed on the outer peripheral edge. A pair of stays is formed on both the left and right sides of the upper portion of the upright portion so as to project further from the upright portion. The pair of stays of the valve body are arranged so as to overlap the stays of the valve body support member, and the valve body is swingably attached to the valve body support member via a pin. A coil spring externally inserted to this pin has one arm fixed to the valve body support member, and the other arm pressing the valve body.

The second and third embodiments of Patent Literature 1 describe a muffler valve which does not use a valve body support member and in which a portion of the separator is cut up to form a pair of stays, and the valve body is attached to the cut-up stays. The fourth embodiment of Patent Literature 1 describes a configuration which does not uses the valve body support member and in which an attachment member having a spring property is rivet-welded to the valve body, the attachment member is rivet-welded to the separator, and the opening of the separator is opened and closed by the spring property of the attachment member. The fifth embodiment of Patent Literature 1 describes a configuration which does not use the valve body support member and in which a valve body formed of a material having a spring property and having a bent portion formed therein is pin-coupled to the separator, and the opening of the separator is opened and closed by the bending of the bent portion.

### CITATION LIST

### Patent Literature

[PTL 1] Japanese Patent Application Publication No. 9-195749

### SUMMARY OF INVENTION

### Technical Problem

By the way, as in the first embodiment of Patent Literature 1, when the tapered portion, the cylindrical portion, the upright portion, and the stay are respectively projected in the front-rear direction by the valve body support member corresponding to the valve seat, and the protrusion, the upright portion, and the stay are projected in the front-rear direction by the valve body, the muffler valve attached to the separator may have an extremely thick shape. Thus, it is inferior in handleability, especially in a narrow space, and attachment inside the muffler becomes difficult. In order to attach the muffler valve, it is necessary to additionally process a flange in the opening of the separator, which increases the manufacturing cost and decreases the manufacturing efficiency.

As in the second and third embodiments of Patent Literature 1, when a portion of the separator is cut up so that the pair of stays project in the thickness direction of the separator, the strength of the separator is lowered, which may decrease the durability of the muffler. As in the fourth and fifth embodiments of Patent Literature 1, in the structure in which the valve body is fixed along the separator with a rivet or a pin and is opened and closed by an attachment member having the spring property or a bent portion, since bending stress is repeatedly applied to the separator and valve body when the valve is opened and closed, the time to damage is shortened, and the durability of the muffler valve and the muffler is also reduced.

The present invention has been proposed in view of the above problems, and an object of the present invention is to provide a muffler valve and a muffler which provide excellent handleability during attachment and can reduce the manufacturing cost. Another object of the present invention is to provide a muffler valve and a muffler that can reduce the manufacturing cost of the muffler and improve the manufacturing efficiency, and can maintain high durability of the muffler.

### Solution to Problem

A muffler valve of the present invention is a muffler valve that opens and closes an exhaust passage according to a pressure of an exhaust gas of an engine, wherein a valve body is swingably supported by a support shaft with respect to a valve seat, the valve body is urged in a closing direction by a spring member externally inserted to the support shaft, a valve seat substrate of the valve seat arranged along the separator is formed in a substantially flat-plate ring shape having an opening in the center, and a valve body substrate of the valve body is formed in a flat dish shape having a flat rim. The muffler valve of the present invention is preferably a muffler valve attached to a separator that partitions the inside of the muffler, but the muffler valve may also be attached to the end of an exhaust pipe installed in the muffler.

According to this configuration, the valve seat substrate of the valve seat of the muffler valve is formed in a substantially flat-plate ring shape, and the valve body substrate of the valve body is formed in a flat dish shape having the flat rim. As a result, the muffler valve can be made compact by eliminating the bulkiness and minimizing the thickness. Therefore, the handleability of the muffler valve during attachment can be improved. In addition, the materials used for manufacturing can be reduced, the manufacturing cost can be reduced, and the weight can be reduced as the materials used are reduced, which can contribute to the improvement of the fuel efficiency of the automobile. When the muffler valve is attached to the separator that partitions the inside of the muffler, the flat-plate ring-shaped valve seat substrate can be arranged and attached near the peripheral edge of the opening of the separator, eliminating the need for additional machining such as forming a flange in the opening of the separator. From this point of view, it is possible to reduce the manufacturing cost of the muffler and improve the manufacturing efficiency. Since a portion of the separator is not cut up to reduce the strength of the separator and the separator is not repeatedly subjected to bending stress, it is possible to maintain the high durability of the muffler.

In the muffler valve of the present invention, the flat rim of the valve body substrate may be formed in a ring shape, and a ring cushioning material having a substantially flat-plate ring shape may be fixed to the valve seat side of the flat rim.

According to this configuration, the flat rim of the valve body substrate is brought into contact with the flat-plate ring-shaped valve seat substrate via the ring cushioning material, and is brought into contact with the valve seat substrate via the ring cushioning material when the valve body is closed. Therefore, it is possible to prevent damage to both the valve body substrate and the valve seat substrate. Since the substantially flat-plate ring-shaped ring cushioning material is arranged and fixed to the valve seat side of the flat rim of the valve body substrate, it is possible to suppress an increase in the thickness of the opening/closing region of the muffler valve due to the installation of the cushioning material, and can secure compactness.

In the muffler valve of the present invention, a thickness of an opening/closing region where the valve body substrate is laminated on the valve seat substrate in a closed state may be equal to or less than a lamination thickness of the flat rim of the valve body, the ring cushioning material, and the valve seat substrate in the closed state.

According to this configuration, it is possible to suppress an increase in the thickness of the opening/closing region of the muffler valve due to the installation of the cushioning material as much as possible, and to secure higher compactness.

In the muffler valve of the present invention, a valve seat hook portion engaged with the support shaft so as to embrace the support shaft in a circumferential direction from the valve seat side may be provided on the valve seat, the valve seat hook portion may be fixed to the support shaft, and a valve body hook portion engaged with the support shaft so as to embrace the support shaft in the circumferential direction from the valve body side may be provided on the valve body.

According to this configuration, the swing mechanism of the valve seat and the valve body can be formed without forming a stay protruding from the valve seat substrate in the plate thickness direction or a stay protruding from the valve body substrate in the plate thickness direction. Moreover, it is possible to eliminate a bulky stay protruding in the thickness direction from the valve seat substrate or the valve body substrate and to secure higher compactness. Therefore, the handleability of the muffler valve during attachment can be further improved, and the muffler valve can be easily attached to a considerably narrow space in the muffler, for example.

In the muffler valve of the present invention, the spring member may be a coil spring, one arm of the coil spring may be led out and arranged on a front side near a root of the valve body hook portion, and the other arm may be led out and arranged on a back side near a root of the valve seat hook portion, and the valve body may be urged in the closing direction by one arm of the coil spring.

According to this configuration, one arm of the coil spring is led out and arranged on the front side near the root of the valve body hook portion, the other arm is led out and arranged on the back side near the root of the other valve seat hook portion, and the valve body is urged in the closing direction by one arm of the coil spring. Therefore, it is possible to constantly urge the valve body in the closing direction while suppressing the bulkiness of the coil spring which is a spring member as much as possible.

In the muffler valve of the present invention, a positioning hook portion engaged with the coil spring so as to embrace the coil spring in the circumferential direction from the valve seat side may be provided on the valve seat.

According to this configuration, the positioning hook portion is engaged so as to embrace the coil spring in the circumferential direction from the valve seat side. Therefore, the position and arrangement state of the coil spring can be further stabilized, and the closing operation of the valve body by the initial closing load of the coil spring can be ensured with high stability.

In the muffler valve of the present invention, a flange may be provided at one end of the support shaft, and the valve seat hook portion and the valve body hook portion may be engaged with the support shaft at a position positioned by the flange.

According to this configuration, the muffler valve can be assembled while positioning with the flange of the support shaft, which facilitates the manufacturing operation of the muffler valve and further enhances the manufacturing efficiency.

In the muffler valve of the present invention, the valve seat hook portions may be provided near both ends of the support shaft, respectively, and the valve seat hook portion on either end or the valve seat hook portions on both ends may be fixed to the support shaft by caulking.

According to this configuration, the need to fix the valve seat hook portion and the support shaft by labor-intensive welding or the like can be eliminated or minimized, and the manufacturing operation of the muffler valve can be facilitated and the manufacturing efficiency can be further improved.

In the muffler valve of the present invention, a positioning recess recessed toward the valve seat side may be provided on a front surface of the valve body substrate, and a weight may be fixed to the valve body substrate by positioning with the positioning recess.

According to this configuration, the installation position of the weight can be stabilized at the positioning recess, and the stability of the fixing of the weight to the valve body substrate by welding or the like can be improved.

In the muffler valve of the present invention, the valve seat substrate may be provided with a welding region protruding outward from an outer peripheral edge of the valve body substrate on the support shaft side and a side opposite to the support shaft.

According to this, for example, when the muffler valve is attached to a separator that partitions the inside of the muffler, the muffler valve can be fixed to the separator simply by welding the valve seat substrate to the vicinity of the peripheral edge of the opening of the separator in a dot shape in the welding region of the valve seat substrate protruding outward from the outer peripheral edge of the valve body substrate. Moreover, the operation of fixing the muffler valve to the separator can be facilitated.

A muffler of the present invention is a muffler in which the valve seat substrate of the muffler valve according to the present invention is fixed to a peripheral edge of an opening of a separator that partitions the inside of the muffler.

According to this, it is possible to obtain a muffler having the effect of the muffler valve of the present invention.

### Advantageous Effects of Invention

According to the present invention, it is possible to improve the handleability during attachment of the muffler valve and reduce the manufacturing cost. Further, when the muffler valve is attached to the separator that partitions the inside of the muffler, it is possible to reduce the manufacturing cost of the muffler, improve the manufacturing efficiency, and maintain high durability of the muffler.

### BRIEF DESCRIPTION OF DRAWINGS

FIG. 1 is a perspective view of the closed state of a muffler valve according to a first embodiment of the present invention as viewed from the valve plate side.

FIG. 2 is a perspective view of the open state of the muffler valve of the first embodiment as viewed from the valve seat side.

FIG. 3 is a vertical cross-sectional view of the muffler valve of the first embodiment in a closed state.

FIG. 4(a) is a front perspective view of the closed state of the muffler valve of the first embodiment, and FIG. 4(b) is a cross-sectional view taken along the line A-A.

FIG. 5(a) is a cross-sectional view corresponding to FIG. 4(b), of a muffler valve of a first modification of the first embodiment, FIG. 5(b) is a cross-sectional view corresponding to FIG. 4(b), of a muffler valve of a second modification of the first embodiment, FIG. 5(c) is a cross-sectional view corresponding to FIG. 4(b), of a muffler valve according to a third modification of the first embodiment, and FIG. 5(d) is a cross-sectional view corresponding to FIG. 4(b), of a muffler valve according to a fourth modification of the first embodiment.

FIG. 6 is an explanatory view of a muffler in which the muffler valve of the first embodiment is attached to a separator.

FIG. 7 is a front view of a state in which the muffler valve of the first embodiment is attached to a separator.

FIG. 8 is a vertical cross-sectional view of a state in which the muffler valve of the first embodiment is attached to a separator.

FIG. 9 is a perspective view of the closed state of the muffler valve according to a second embodiment of the present invention as viewed from the valve plate side.

FIG. 10 is a vertical sectional view of the muffler valve according to the second embodiment in a closed state.

### DESCRIPTION OF EMBODIMENTS

### [Muffler Valve of First Embodiment]

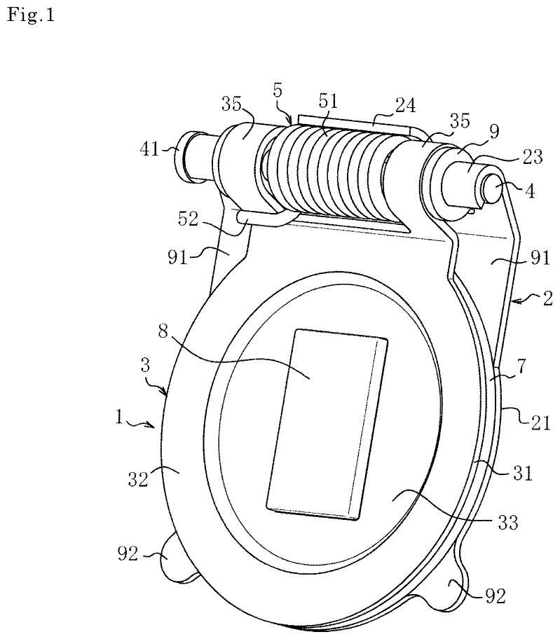

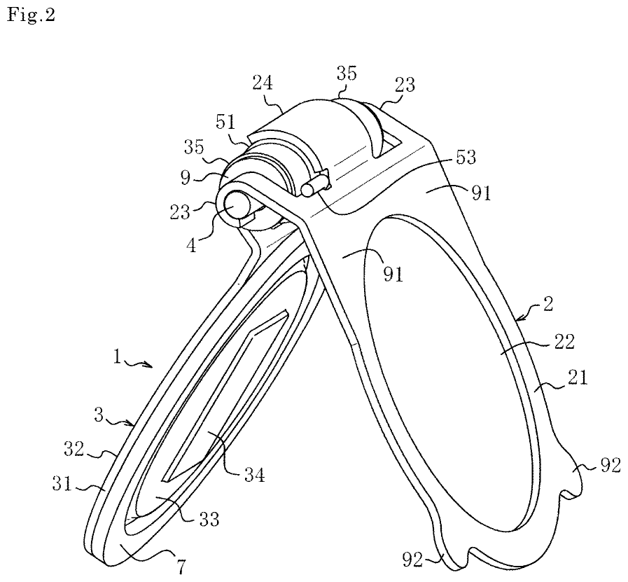

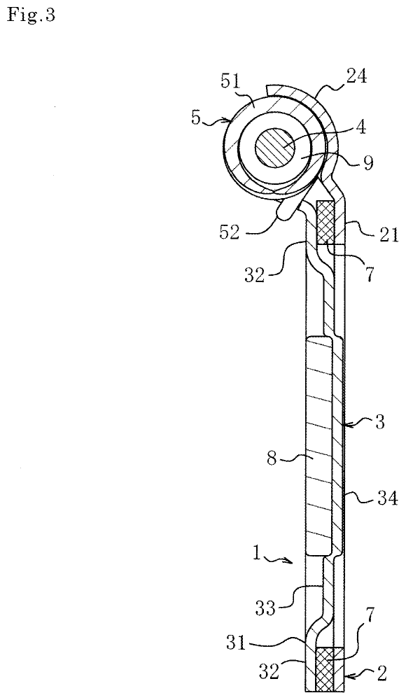

A muffler valve 1 of a first embodiment according to the present invention is installed in a muffler of an exhaust system of an automobile and opens and closes an exhaust passage according to the pressure of an exhaust gas of the engine. Particularly, the muffler valve 1 is attached to a separator that partitions the inside of the muffler. As shown in FIGS. 1 to 4, the muffler valve 1 includes a valve seat 2, a valve body 3 that opens and closes, a support shaft 4, and a coil spring 5 that is a spring member. The valve body 3 is swingably supported by the support shaft 4 with respect to the valve seat 2, and is urged in a closing direction by the coil spring 5 externally inserted to the support shaft 4.

The valve seat 2 has a valve seat substrate 21 formed in a substantially flat-plate ring shape arranged along the separator, and an opening 22 constituting an exhaust passage opened and closed is formed at the center of the valve seat substrate 21. The valve seat 2 is provided with a valve seat hook portion 23 that protrudes from the support shaft 4 side of the valve seat substrate 21 and is formed in a hook shape. The valve seat hook portion 23 is integrally formed with the valve seat substrate 21 such that an upper portion in the drawing of the valve seat substrate 21 is bent. The valve seat hook portion 23 of the present embodiment is formed as a pair of valve seat hook portions 23 and 23 at positions corresponding to both ends in the width direction of the valve seat substrate 21, and the valve seat hook portions 23 and 23 are provided near both ends of the support shaft 4.

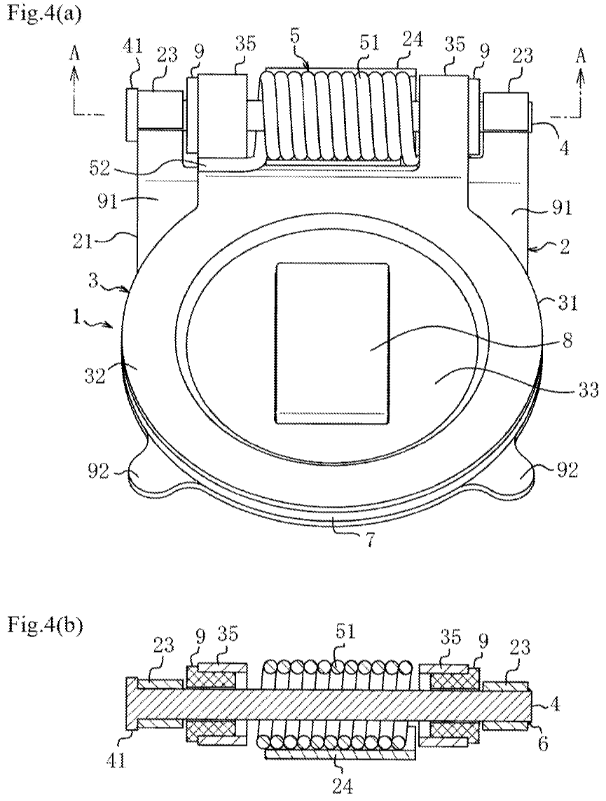

The valve seat hook portion 23 is engaged with the support shaft 4 so as to embrace the support shaft 4 from the valve seat 2 side or from the upper side in the drawing in the circumferential direction, and is fixed to the support shaft 4. The inner peripheral surface of the tip end of the valve seat hook portion 23 has a shape and a size that substantially follow the shape and size of the outer peripheral surface of the support shaft 4. In the examples of FIGS. 1 to 4, a flange 41 is integrally provided at one end of the support shaft 4, and the support shaft 4 is inserted into the pair of valve seat hook portions 23 and 23 from the end side where the flange 41 is not provided. The flange 41 abuts on the outer surface of one valve seat hook portion 23 and is positioned, and the valve seat hook portions 23 and 23 are engaged with the support shaft 4 at this positioned position. The support shaft 4 that is inserted into and engaged with the other valve seat hook portion 23 and slightly protrudes outward from the other valve seat hook portion 23 is welded and fixed to the other valve seat hook portion 23 at the welding portion 6 around the protruding position (see FIG. 4(b)).

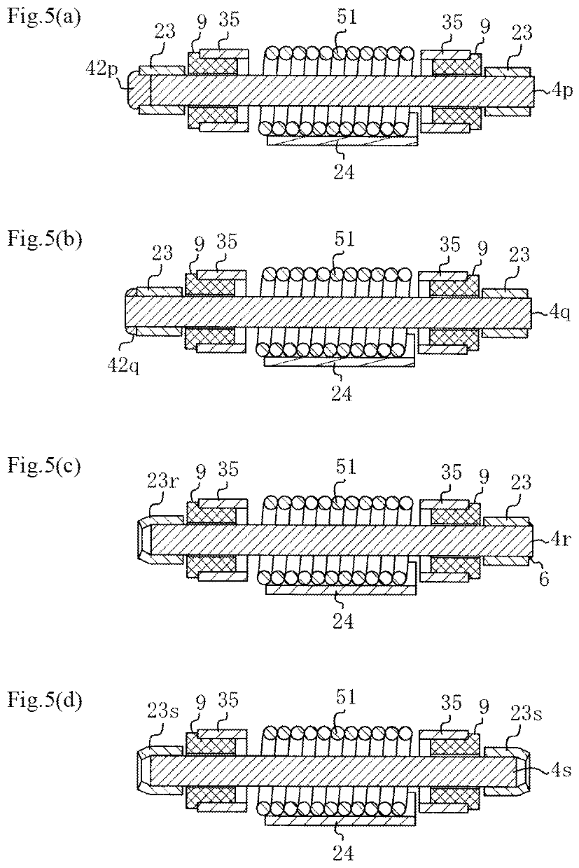

As the configuration of fixing the valve seat hook portion 23 and the support shaft 4, a configuration of the first to fourth modifications shown in FIG. 5 are preferable to be used, in addition to the example of FIG. 4(b). The support shaft may be a rod-shaped support shaft without a flange, and the support shaft may be fixed to one valve seat hook portion 23 and the other valve seat hook portion 23 by the welding the welding portion 6 described later.

In the first modification of FIG. 5(a), one end of a support shaft 4p engaged with the valve seat hook portions 23 and 23 is arranged at a position recessed from the one valve seat hook portion 23. The welding portion 42p is formed so as to enter one of the valve seat hook portions 23 and fill the holes, and one end of the support shaft 4p is fixed to the one valve seat hook portion 23 at the welding portion 42p. The support shaft 4p slightly protruding outward from the other valve seat hook portion 23 is not welded to the other valve seat hook portion 23, and the welding operation is reduced. However, the support shaft 4p may be welded and fixed to the other valve seat hook portion 23 at the welding portion 6 around the protruding position in the same manner as described above. In the first modification, the positioning by the flange 41 at one end of the support shaft 4 cannot be realized, but since it is not necessary to process the portion of the support shaft 4p corresponding to the flange 41, the machining cost of the support shaft 4p can be reduced. Other configurations of the first modification are the same as the muffler valve 1 of FIGS. 1 to 4.

In the second modification of FIG. 5(b), one end of a support shaft 4q engaged with the valve seat hook portions 23 and 23 is arranged at a position protruding outward slightly longer than the one valve seat hook portion 23. One valve seat hook portion 23 and a portion of one end of the support shaft 4q protruding from one valve seat hook portion 23 are fixed by a welding portion 42q of fillet welding, and one end of the support shaft 4q is fixed to one valve seat hook portion 23 at the welding portion 42q. The support shaft 4q slightly protruding outward from the other valve seat hook portion 23 is not welded to the other valve seat hook portion 23, and the welding operation is reduced. However, the support shaft 4q may be welded and fixed to the other valve seat hook portion 23 at the welding portion 6 around the protruding portion in the same manner as described above. In the second modification, the positioning by the flange 41 at one end of the support shaft 4 cannot be realized, but since it is not necessary to process the portion of the support shaft 4q corresponding to the flange 41, the machining cost of the support shaft 4q can be reduced. Other configurations of the second modification are the same as the muffler valve 1 of FIGS. 1 to 4.

In the third modification of FIG. 5(c), a rod-shaped support shaft 4r without a flange is provided, and the support shaft 4r is inserted into a pair of valve seat hook portions 23r and 23, so that the valve seat hook portions 23r and 23 are engaged with the support shaft 4r. The valve seat hook portion 23r at one end of both ends is fixed to the support shaft 4r by caulking, in other words, the support shaft 4r is fixed to the one valve seat hook portion 23r by caulking. The support shaft 4r, which is inserted into and engaged with the valve seat hook portion 23 at the other end of both ends and slightly protrudes outward from the other valve seat hook portions 23, is welded and fixed to the other valve seat hook portion 23 at the welding portion 6 around the protruding portion. Other configurations of the third modification are the same as the muffler valve 1 of FIGS. 1 to 4.

In the fourth modification of FIG. 5(d), a rod-shaped support shaft 4s without a flange is provided, and the support shaft 4s is inserted into a pair of valve seat hook portions 23s and 23s, so that the valve seat hook portions 23s and 23s are engaged with the support shaft 4s. The valve seat hook portion 23s at one end of both ends is fixed to the support shaft 4s by caulking, in other words, the support shaft 4s is fixed to the one valve seat hook portion 23s by caulking. The valve seat hook portion 23s at the other end of both ends is also fixed to the support shaft 4s by caulking, in other words, the support shaft 4s is fixed to the other valve seat hook portion 23s by caulking. That is, in the fourth modification, the valve seat hook portions 23s and 23s at both ends are fixed to the support shaft 4s by caulking. Other configurations of the fourth modification are the same as the muffler valve 1 of FIGS. 1 to 4.

The valve body 3 has a valve body substrate 31, and the valve body substrate 31 is formed in a flat dish shape having a flat rim 32. The flat rim 32 is formed in a ring shape, and a ring cushioning material 7 having a substantially flat-plate ring shape is fixed to the valve seat 2 side of the flat rim 32. As the ring cushioning material 7, it is possible to use an appropriate cushioning material having a cushioning function such as elasticity and heat resistance, and for example, a metal mesh material is preferable.

A recess 33 having a substantially circular shape in a plan view, which is recessed on the valve seat 2 side, is provided on the front surface of the valve body substrate 31, and the recess 33 and the flat rim 32 form a flat dish shape of the valve body substrate 31. A positioning recess 34 having a substantially rectangular shape in a plan view, which is recessed toward the valve seat 2 side, is formed substantially at the center of the recess 33, and the recess 33 and the positioning recess 34 form a multi-stage recess in the valve body substrate 31. A weight 8 is positioned on the valve body substrate 31 by the positioning recess 34 and is fixed to the valve body substrate 31 by welding or the like. The weight 8 of the first embodiment has a substantially rectangular parallelepiped shape having a low height, and the weight 8 having a substantially rectangular parallelepiped shape is engaged with and positioned at the positioning recess 34 having a substantially rectangular shape in a plan view, and the weight 8 is fixed to the valve body substrate 31 by welding at the edge portion of the positioning recess 34.

The height of the recess 33 and the positioning recess 34 protruding toward the back surface of the valve body substrate 31 is set to be equal to or less than the thickness of the ring cushioning material 7 and the valve seat substrate 21 laminated, and the height of the upper surface of the weight 8 fixed to the valve body substrate 31 is set to be equal to or less than the height of the upper surface of the flat rim 32 of the valve body substrate 31. By doing so, the thickness of the opening/closing region where the valve body substrate 31 is laminated on the valve seat substrate 21 in the closed state can be set to be equal to or less than the lamination thickness in the closed state of the flat rim 32 of the valve body 3, the ring cushioning material 7, and the valve seat substrate 21, which is preferable. In this way, an increase in the thickness of the opening/closing region of the muffler valve 1 due to the installation of the ring cushioning material 7 can be suppressed as much as possible. When the thickness of the opening/closing region where the valve body substrate 31 is laminated on the valve seat substrate 21 in the closed state is set to be equal to or less than the lamination thickness in the closed state of the flat rim 32 of the valve body 3, the ring cushioning material 7, and the valve seat substrate 21, the lamination thickness is preferably set to 4.0 to 6.0 mm, for example, if the plate thickness of the flat rim 32 of the valve body 3 is 1.0 to 1.5 mm, the plate thickness of the valve seat substrate 21 is 1.0 to 1.5 mm, and the thickness of the ring cushioning material 7 is 2.0 to 3.0 mm.

The valve body 3 is provided with a valve body hook portion 35 that protrudes from the support shaft 4 side of the valve body substrate 31 and is formed in a book shape. The valve body hook portion 35 is integrally formed with the valve body substrate 31 such that an upper portion in the drawing of the valve body substrate 31 is bent. The valve body hook portion 35 of the present embodiment is formed at a position on the inner side of the pair of valve seat hook portions 23 and 23 as a pair of valve body hook portions 35 and 35 at intervals. One valve seat hook portions 23 and one valve body hook portion 35, and the other valve seat hook portion 23 and the other valve body hook portion 35 are arranged in close proximity to each other.

The valve body hook portion 35 is provided so as to be engaged with the support shaft 4 so as to embrace the support shaft 4 from the valve body 3 side or from the upper side in the drawing in the circumferential direction. In the present embodiment, the cylinder cushioning materials 9 and 9 are fitted and fixed to the positions of the support shaft 4 corresponding to the pair of valve body hook portions 35 and 35, respectively, and the valve body hook portions 35 and 35 are engaged with the support shaft 4 via the cylinder cushioning materials 9 and 9. The inner peripheral surface of the tip end of the valve seat hook portion 35 has a shape and a size that substantially follow the shape and size of the outer peripheral surface of the cylinder cushioning material 9. As the cylinder cushioning material 9, it is possible to use an appropriate cushioning material having a cushioning function such as elasticity and heat resistance, and for example, a metal mesh material is preferable. The valve body hook portions 35 are engaged with the support shaft 4 at a position where the support shaft 4 is positioned by the flange 41, similarly to the valve seat hook portions 23 and 23.

The main body 51 around which the coil spring 5 is wound is arranged between the pair of valve body hook portions 35 and 35 and is externally inserted to the support shaft 4. One arm 52 of the coil spring 5 is led out and arranged on the front side near the root of one valve body hook portion 35, and the other arm 53 of the coil spring 5 is led out and arranged on the back side near the root of the other valve seat hook portion 23. The valve body 3 is urged in the closing direction by one arm 52 of the coil spring 5.

The valve seat 2 is provided with a positioning hook portion 24 that protrudes from the support shaft 4 side of the valve seat substrate 21 and is formed in a hook shape. The positioning hook portion 24 is integrally formed with the valve seat substrate 21 such that an upper portion in the drawing of the valve seat substrate 21 is bent. The positioning hook portion 24 is provided at a substantially central position separated from one valve seat hook portion 23 and the other valve seat hook portion 23, and is provided at a position between the pair of valve body hook portions 35 of the valve body 3 and the other valve body hook portion 35. The positioning hook portion 24 is arranged at the position corresponding to the main body 51 of the coil spring 5.

The positioning hook portion 24 is engaged with the coil spring 5 so as to embrace the coil spring 5 from the valve seat 2 side in the circumferential direction. The inner peripheral surface of the positioning hook portion 24 has a shape and a size that substantially follow the shape and size of the outer peripheral surface of the main body 51 of the coil spring 5. The positioning hook portion 24 is engaged so as to embrace the main body 51 of the coil spring 5 in the circumferential direction.

The valve seat substrate 21 of the valve seat 2 is provided with welding regions 91 and 92 protruding outward from the outer peripheral edge of the valve body substrate 31 of the closed valve body 3 on the support shaft 4 side and the side opposite to the support shaft 4. In the present embodiment, four welding regions 91 and 92 in total including two welding regions 91 and 91 on the support shaft 4 side and two welding regions 92 and 92 on the opposite side of the support shaft 4 are provided, and the welding regions 92 and 92 on the opposite side of the support shaft 4 are formed in a tongue shape.

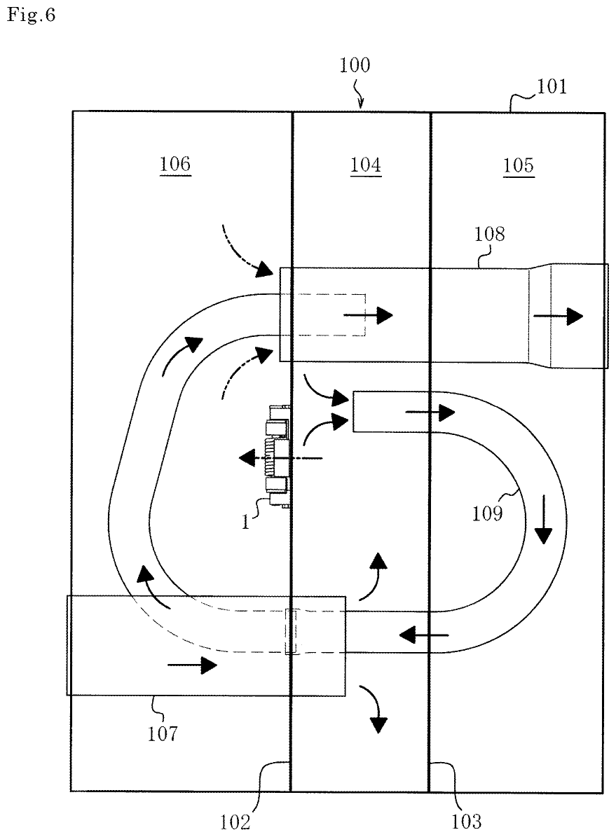

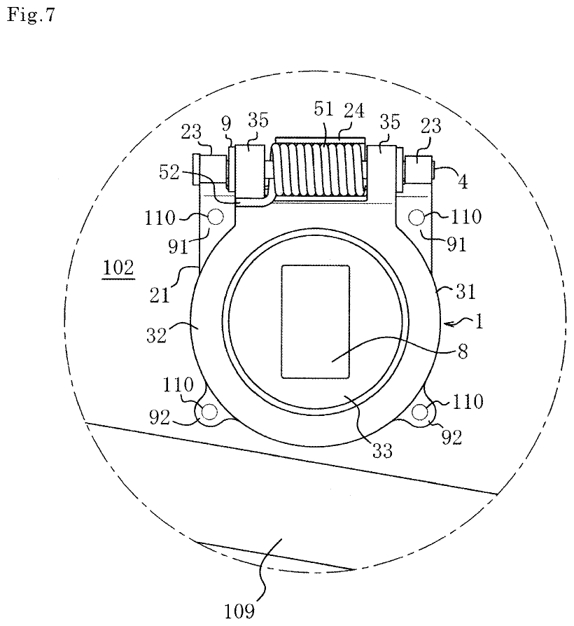

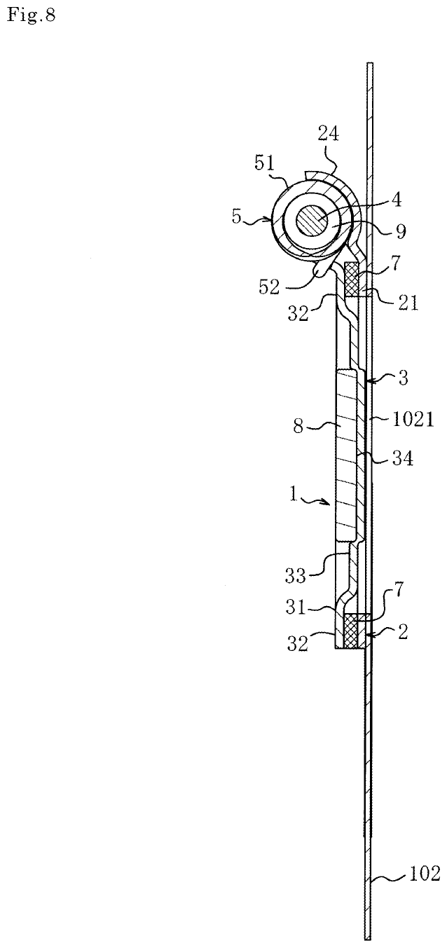

The muffler valve 1 of the first embodiment is attached to, for example, the separator 102 of the muffler 100 shown in FIGS. 6 to 8. In the muffler 100, the inside of the housing 101 is partitioned by a first separator 102 and a second separator 103 having a flat-plate shape, whereby an expansion chamber 104, a resonance chamber 105, and an expansion chamber 106 are provided. A large number of small holes (not shown) are formed over the entire surface of the second separator 103 that partitions the expansion chamber 104 and the resonance chamber 105.

The muffler 100 includes an exhaust introduction pipe 107 that communicates with an exhaust pipe of the engine and introduces an exhaust gas into the housing 101, and an exhaust outlet pipe 108 that leads out an exhaust gas from the housing 101. The exhaust introduction pipe 107 is provided so as to pass through the first separator 102 so as to cross the expansion chamber 106 from the outer wall on the expansion chamber 106 side, and the expansion chamber 104 serves as an exhaust port of the exhaust introduction pipe 107. The exhaust outlet pipe 108 is provided so as to pass through the second separator 103 and the first separator 102 so as to cross the resonance chamber 105 and the expansion chamber 104 with the outer wall on the resonance chamber 105 side as an exhaust port, and the expansion chamber 106 serves as an inlet port of the exhaust outlet pipe 108.

An exhaust distribution pipe 109 that bends in a substantially σ-shape is provided in the housing 101, and the exhaust distribution pipe 109 is formed to have a smaller diameter than the exhaust introduction pipe 107 and the exhaust outlet pipe 108. The exhaust distribution pipe 109 has an intake port opened to the expansion chamber 104, and is arranged so as to pass through the second separator 103 at two locations on the inlet side and the outlet side and cross the resonance chamber 105 in a substantially arc shape. The exhaust distribution pipe 109 is arranged so as to cross the expansion chamber 104 and pass through the first separator 102. The exhaust distribution pipe 109 is curved so as to fold back in the expansion chamber 106, so that the exhaust port is arranged near the inlet of the exhaust outlet pipe 108.

The muffler valve 1 is provided on the expansion chamber 106 side of the first separator 102, and is arranged so as to close the opening 1021 at a position corresponding to the opening 1021 which serves as an exhaust passage of the first separator 102. In the muffler valve 1, the valve seat substrate 21 having a substantially flat-plate ring shape is arranged so as to correspond to the peripheral edge of the opening 1021 of the first separator 102. The valve seat substrate 21 is welded at a welding portion 110 such as spot welding in the welding regions 91 and 92. The valve seat substrate 91 is fixed to the peripheral edge of the opening 1021 of the first separator 102.

In the muffler 100, when the pressure of an exhaust gas of the engine is less than a predetermined pressure, the exhaust gas flows as indicated by the thick solid line arrow in FIG. 6. The exhaust gas flows in the order, from the exhaust introduction pipe 107, to the expansion chamber 104, the exhaust distribution pipe 109 in the expansion chamber 104, the exhaust distribution pipe 109 in the resonance chamber 105, the exhaust distribution pipe 109 in the expansion chamber 104, the exhaust distribution pipe 109 in the expansion chamber 106, and the exhaust outlet pipe 108. At this time, the valve body 3 of the muffler valve 1 is continuously urged by the coil spring 5 in the closing direction, valve body 3 is maintained in the closed state, and a high sound deadening effect is exhibited.

When the pressure of an exhaust gas of the engine is equal to or higher than a predetermined pressure in the muffler 100, the valve body 3 of the muffler valve 1 is opened by the pressure of the exhaust gas against the urging of the coil spring 5 in the closing direction. In addition to the flow of the exhaust gas of the thick solid line arrow in FIG. 6, the flow of the exhaust gas of the thick two-dot chain line arrow is generated. That is, the flow of the exhaust gas flowing in the order, from the exhaust introduction pipe 107, to the expansion chamber 104, the exhaust passage of the muffler valve 1 in the open state, the expansion chamber 106, the gap between the exhaust distribution pipe 109 and the exhaust outlet pipe 108, and the exhaust outlet pipe 108 is added, and the back pressure of the exhaust gas of the engine is reduced. After that, when the pressure of an exhaust gas of the engine drops below a predetermined pressure, the valve body 3 closes while being buffered by the ring cushioning material 7, and the valve body substrate 31 abuts on the valve seat substrate 21 via the ring cushioning material 7.

According to the muffler valve 1 of the first embodiment, the valve seat substrate 21 of the valve seat 2 is formed in a substantially flat-plate ring shape, and the valve body substrate 31 of the valve body 3 is formed in a flat dish shape having the flat rim 32. As a result, the muffler valve 1 can be made compact by eliminating the bulkiness and minimizing the thickness. Therefore, the handleability of the muffler valve 1 during attachment can be improved. In addition, the materials used for manufacturing can be reduced, the manufacturing cost can be reduced, and the weight can be reduced as the materials used are reduced, which can contribute to the improvement of the fuel efficiency of the automobile. The flat-plate ring-shaped valve seat substrate 21 can be arranged and attached near the peripheral edge of the opening 1021 of the separator 102 of the muffler 100, eliminating the need for additional machining such as forming a flange in the opening of the separator 102. From this point of view, it is possible to reduce the manufacturing cost of the muffler 100 and improve the manufacturing efficiency. Since a portion of the separator is not cut up to reduce the strength of the separator and the separator is not repeatedly subjected to bending stress, it is possible to maintain the high durability of the muffler 100.

The flat rim 32 of the valve body substrate 31 is formed in a ring shape, and the ring cushioning material 7 having a substantially flat-plate ring shape is arranged on the valve seat 2 side of the flat rim 32 and is fixed to the flat rim 32 of the valve body substrate 31. The flat rim 32 of the valve body substrate 31 can be brought into contact with the flat-plate ring-shaped valve seat substrate 21 via the ring cushioning material 7, and can be brought into contact with the valve seat substrate 21 via the ring cushioning material 7 when the valve body 3 is closed. Therefore, it is possible to prevent damage to both the valve body substrate 31 and the valve seat substrate 21. The substantially flat-plate ring-shaped ring cushioning material 7 can suppress an increase in the thickness of the opening/closing region of the muffler valve 1 due to the installation of the cushioning material, and can secure compactness.

The thickness of the opening/closing region where the valve body substrate 31 is laminated on the valve seat substrate 21 in the closed state is equal to or less than the lamination thickness in the closed state of the flat rim 32 of the valve body 3, the ring cushioning material 7, and the valve seat substrate 21. By doing so, it is possible to suppress an increase in the thickness of the opening/closing region of the muffler valve 1 due to the installation of the cushioning material as much as possible, and to secure higher compactness.

The valve seat hook portion 23 engaged with the support shaft 4 so as to embrace the support shaft 4 in the circumferential direction from the valve seat 2 side is provided on the valve seat 2, the valve seat hook portion 23 is fixed to the support shaft 4, and the valve body hook portion 35 engaged with the support shaft 4 so as to embrace the support shaft 4 in the circumferential direction from the valve body 3 side is provided on the valve body 3. The swing mechanism of the valve seat 2 and the valve body 3 can be formed without forming a stay protruding from the valve seat substrate in the plate thickness direction or a stay protruding from the valve body substrate in the plate thickness direction. Moreover, it is possible to eliminate a bulky stay protruding in the thickness direction from the valve seat substrate or the valve body substrate and to secure higher compactness. Therefore, the handleability of the muffler valve 1 during attachment can be further improved, and the muffler valve 1 can be easily attached to a considerably narrow space in the muffler, for example.

The spring member is the coil spring 5, one arm 52 of the coil spring 5 is led out and arranged on the front side near the root of the valve body hook portion 35, the other arm 53 is led out and arranged on the back side near the root of the other valve seat hook portion 23, and the valve body 3 is urged in the closing direction by one arm 52 of the coil spring 5. Therefore, it is possible to constantly urge the valve body 3 in the closing direction while suppressing the bulkiness of the coil spring 5 which is a spring member as much as possible.

The positioning hook portion 24 of the valve seat 2 is engaged so as to embrace the coil spring 5 or its main body 51 in the circumferential direction from the valve seat 3 side. Therefore, the position and arrangement state of the coil spring 5 can be further stabilized, and the closing operation of the valve body 3 by the initial closing load of the coil spring 5 can be ensured with high stability.

The flange 41 is provided at one end of the support shaft 4, and the valve seat hook portion 23 and the valve body hook portion 35 are engaged with the support shaft 4 at a position positioned by the flange 41. Therefore, the muffler valve 1 can be assembled while positioning with the flange 41 of the support shaft 4, which facilitates the manufacturing operation of the muffler valve 1 and further enhances the manufacturing efficiency.

The valve seat hook portions 23, 23r, and 23s are provided near both ends of the support shafts 4r and 4s, respectively, and the valve seat hook portion 23r at one end of both ends or the valve seat hook portions 23s and 23s at both ends are fixed to the support shafts 4r and 4s by caulking. Therefore, the need to fix the valve seat hook portions 23r, 23s and the support shafts 4r and 4s by labor-intensive welding or the like can be eliminated or minimized, and the manufacturing operation of the muffler valve 1 can be facilitated and the manufacturing efficiency can be further improved.

The positioning recess 34 recessed toward the valve seat 2 is provided on the front surface of the valve body substrate 31, and the weight 8 is fixed to the valve body board 31 by positioning with the positioning recess 34. The installation position of the weight 8 can be stabilized at the positioning recess 34, and the stability of the fixing of the weight 8 to the valve body substrate 31 by welding or the like can be improved.

The valve seat substrate 21 is provided with the welding regions 91 and 92 protruding outward from the outer peripheral edge of the valve body substrate 31 on the support shaft 4 side and the side opposite to the support shaft 4. Therefore, the muffler valve 1 can be fixed to the separator 102 in the welding regions 91 and 92 simply by welding the valve seat substrate 21 to a flat surface near the peripheral edge of the opening 1021 of the separator 102 in a dot shape. Moreover, the operation of fixing the muffler valve 1 to the separator 102 can be facilitated.

### [Muffler Valve of Second Embodiment]

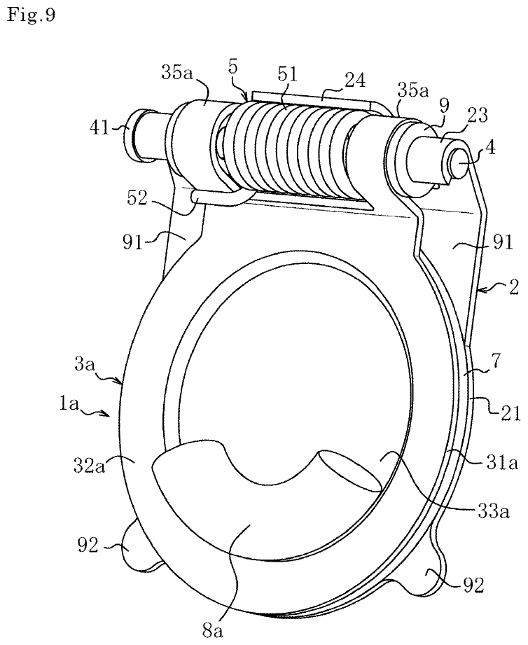

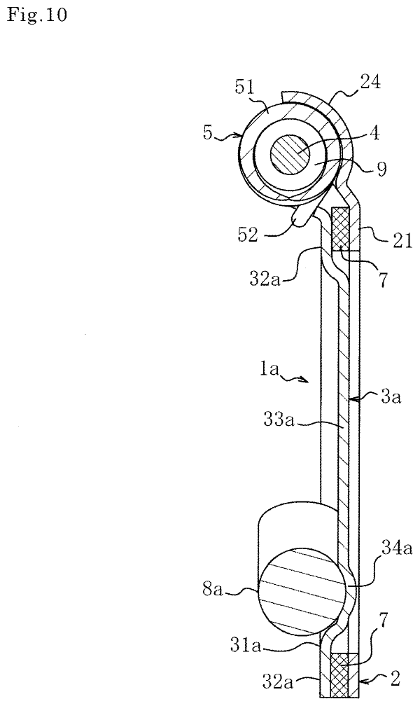

In the muffler valve 1a according to the second embodiment of the present invention, as shown in FIGS. 9 and 10, a recess 33a having a substantially circular shape in a plan view recessed toward the valve seat 2 side is provided on the front surface of the valve body substrate 31a of the valve body 3a, and the recess 33a and the flat rim 32a form a flat dish shape of the valve body substrate 31a. A positioning recess 34a having a substantially are shape in a plan view recessed toward the valve seat 2 is formed at the end of the recess 33a on the opposite side of the support shaft 4, and the positioning recess 34a is formed so as to substantially follow the peripheral edge of the recess 33a. The positioning recess 34a and the recess 33a form a multi-step recess at the end of the valve body substrate 31a on the opposite side of the support shaft 4. A substantially arc-shaped cylindrical weight 8a is positioned on the valve body substrate 31a by the positioning recess 34a, and the weight 8a is fixed to the valve body substrate 31a by welding or the like at the edge of the positioning recess 34a. The valve body 3a is provided with valve body hook portions 35a and 35a having the same configuration as the valve body hook portion 35.

Other configurations of the muffler valve 1a of the second embodiment are the same as those of the muffler valve 1 of the first embodiment. The muffler valve 1a of the second embodiment is also used by fixing the valve seat substrate 21 to the peripheral edge of the opening 1021 of the separator 102 and installing it on the muffler 100 or the like.

According to the second embodiment, the corresponding effect can be obtained from the configuration corresponding to the first embodiment.

### SCOPE OF INCLUSION OF INVENTION DISCLOSED IN PRESENT SPECIFICATION

The invention disclosed in the present specification includes each invention and each embodiment, and, within an applicable range, an invention specified by changing a partial configuration thereof to another configuration disclosed in the present specification, an invention specified by adding another configuration disclosed in the present specification to the configuration thereof and an invention obtained by reducing, specifying and highly conceptualizing the partial configuration thereof as long as a partial effect is acquired. The invention disclosed in the present specification includes the following modified embodiments and postscripts.

For example, in the above embodiment, the ring cushioning material 7 having a substantially flat-plate ring shape is fixed to the valve seat 2 side of the flat rims 32 of the valve body substrates 31 and 31a. However, the ring cushioning material 7 may be fixed to the valve seat substrate 21, and the ring cushioning material 7 may not be fixed to the valve seat 2 side of the flat rim 32. Also in this case, the thickness of the opening/closing region where the valve body substrate 31 is laminated on the valve seat substrate 21 in the closed state may preferably be set to be equal to or less than the lamination thickness of the flat rim 32 of the valve body 3, the ring cushioning material 7, and the valve seat substrate 21 in the closed state. The ring cushioning material 7 may be a ring cushioning material having a substantially circular shape in a cross-sectional view or a substantially elliptical shape in a cross-sectional view instead of a substantially flat-plate ring shape. In particular, when the ring cushioning material 7 is a ring cushioning material having a substantially elliptical shape in a cross-sectional view or a substantially race track shape in a cross-sectional view, the lamination thickness of the flat rim 32 of the valve body 3, the ring cushioning material 7, and the valve seat substrate 21 in the closed state can be reduced, which is preferable.

The muffler valve of the present invention includes a muffler valve having an appropriate configuration in which the valve seat substrate of the valve seat arranged along the separator is formed in a substantially flat-plate ring shape having an opening in the center, and the valve body substrate of the valve body has a flat dish shape having a flat rim. The muffler valve is not limited to one in which the valve seat hook portion 23 and the valve body hook portion 35 are provided. As the spring member in the muffler valve of the present invention, an appropriate material can be used within the scope of the purpose of the present invention in addition to the coil spring 5. The muffler valve of the present invention also includes a muffler valve in which a weight is not provided on the valve body substrate. As the configuration of fixing the valve seat substrate of the muffler valve of the present invention to the peripheral edge of the opening of the separator of the muffler, an appropriate fixing configuration can be used within the scope of the purpose of the present invention in addition to welding at the welding portions 110 of the welding regions 91 and 92. The muffler valve of the present invention is preferably a muffler valve attached to a separator that partitions the inside of the muffler, but the muffler valve may also be attached to the end of an exhaust pipe installed in the muffler.

The invention disclosed in the present specification includes a muffler valve in which the valve seat substrate of the valve seat is formed in a shape other than the substantially flat-plate ring shape, or the valve body substrate of the valve body is formed in a shape other than the flat dish shape having a flat rim, or the valve seat substrate of the valve seat is formed in a shape other than a substantially flat-plate ring shape, the valve body substrate of the valve body is formed in a shape other than a flat dish shape having a flat rim, and the valve seat hook portion engaged with the support shaft so as to embrace the support shaft in the circumferential direction from the valve seat side is provided on the valve seat, the valve seat hook portion is fixed to the support shaft, and the valve body hook portion engaged with the support shaft so as to embrace the support shaft in the circumferential direction from the valve body side is provided on the valve body.

### INDUSTRIAL APPLICABILITY

The present invention can be used as a muffler valve attached to a separator that partitions the inside of a muffler of an exhaust system of an automobile.

### REFERENCE SIGNS LIST

1, 1a Muffler valve
2 Valve seat
21 Valve seat substrate
22 Opening
23, 23r, 23s Valve seat hook portion
24 Positioning hook portion
3, 3a Valve body
31, 31a Valve body substrate
32, 32a Flat rim
33, 33a Recess
34, 34a Positioning recess
35, 35a Valve body hook portion
4, 4p, 4q, 4r, 4s Support shaft
41 Flange
42p, 42q Welding portion
5 Coil spring
51 Main body
52 One arm
53 the other arm
6 Welding portion
7 Ring cushioning material
8, 8a Weight
9 Cylinder cushioning material
91, 92 Welding region
100 Muffler
101 Housing
102 First separator
1021 Opening
103 Second separator
104 Expansion chamber
105 Resonance chamber
106 Expansion chamber
107 Exhaust introduction pipe
108 Exhaust outlet pipe
109 Exhaust distribution pipe
110 Welding portion

1-11. (canceled)

12. A muffler valve that opens and closes an exhaust passage according to a pressure of an exhaust gas of an engine, wherein
a valve body is swingably supported by a support shaft with respect to a valve seat,
the valve body is urged in a closing direction by a spring member externally inserted to the support shaft,
a valve seat substrate of the valve seat arranged along a separator is formed in a substantially flat-plate ring shape having an opening in the center, and
a valve body substrate of the valve body is formed in a flat dish shape having a flat rim.

13. The muffler valve according to claim 12, wherein
the flat rim of the valve body substrate is formed in a ring shape, and
a ring cushioning material having a substantially flat-plate ring shape is fixed to the valve seat side of the flat rim.

14. The muffler valve according to claim 13, wherein a thickness of an opening/closing region where the valve body substrate is laminated on the valve seat substrate in a closed state is equal to or less than a lamination thickness of the flat rim of the valve body, the ring cushioning material, and the valve seat substrate in the closed state.

15. The muffler valve according to claim 12, wherein
a valve seat hook portion engaged with the support shaft so as to embrace the support shaft in a circumferential direction from the valve seat side is provided on the valve seat,
the valve seat hook portion is fixed to the support shaft, and
a valve body hook portion engaged with the support shaft so as to embrace the support shaft in the circumferential direction from the valve body side is provided on the valve body.

16. The muffler valve according to claim 13, wherein
a valve seat hook portion engaged with the support shaft so as to embrace the support shaft in a circumferential direction from the valve seat side is provided on the valve seat,
the valve seat hook portion is fixed to the support shaft, and
a valve body hook portion engaged with the support shaft so as to embrace the support shaft in the circumferential direction from the valve body side is provided on the valve body.

17. The muffler valve according to claim 14, wherein
a valve seat hook portion engaged with the support shaft so as to embrace the support shaft in a circumferential direction from the valve seat side is provided on the valve seat,
the valve seat hook portion is fixed to the support shaft, and
a valve body hook portion engaged with the support shaft so as to embrace the support shaft in the circumferential direction from the valve body side is provided on the valve body.

18. The muffler valve according to claim 15, wherein
the spring member is a coil spring,
one arm of the coil spring is led out and arranged on a front side near a root of the valve body hook portion, and the other arm is led out and arranged on a back side near a root of the valve seat hook portion, and
the valve body is urged in the closing direction by one arm of the coil spring.

19. The muffler valve according to claim 16, wherein
the spring member is a coil spring,
one arm of the coil spring is led out and arranged on a front side near a root of the valve body hook portion, and the other arm is led out and arranged on a back side near a root of the valve seat hook portion, and
the valve body is urged in the closing direction by one arm of the coil spring.

20. The muffler valve according to claim 17, wherein
the spring member is a coil spring,
one arm of the coil spring is led out and arranged on a front side near a root of the valve body hook portion, and the other arm is led out and arranged on a back side near a root of the valve seat hook portion, and
the valve body is urged in the closing direction by one arm of the coil spring.

21. The muffler valve according to claim 18, wherein
a positioning hook portion engaged with the coil spring so as to embrace the coil spring in the circumferential direction from the valve seat side is provided on the valve seat.

22. The muffler valve according to claim 19, wherein
a positioning hook portion engaged with the coil spring so as to embrace the coil spring in the circumferential direction from the valve seat side is provided on the valve seat.

23. The muffler valve according to claim 20, wherein
a positioning hook portion engaged with the coil spring so as to embrace the coil spring in the circumferential direction from the valve seat side is provided on the valve seat.

24. The muffler valve according to claim 15, wherein
a flange is provided at one end of the support shaft, and
the valve seat hook portion and the valve body hook portion are engaged with the support shaft at a position positioned by the flange.

25. The muffler valve according to claim 18, wherein
a flange is provided at one end of the support shaft, and
the valve seat hook portion and the valve body hook portion are engaged with the support shaft at a position positioned by the flange.

26. The muffler valve according to claim 21, wherein
a flange is provided at one end of the support shaft, and
the valve seat hook portion and the valve body hook portion are engaged with the support shaft at a position positioned by the flange.

27. The muffler according to claim 15, wherein
the valve seat hook portions are provided near both ends of the support shaft, respectively, and
the valve seat hook portion on either end or the valve seat hook portions on both ends is/are fixed to the support shaft by caulking.

28. The muffler according to claim 18, wherein
the valve seat hook portions are provided near both ends of the support shaft, respectively, and
the valve seat hook portion on either end or the valve seat hook portions on both ends is/are fixed to the support shaft by caulking.

29. The muffler according to claim 21, wherein
the valve seat hook portions are provided near both ends of the support shaft, respectively, and
the valve seat hook portion on either end or the valve seat hook portions on both ends is/are fixed to the support shaft by caulking.

30. The muffler valve according to claim 12, wherein
a positioning recess recessed toward the valve seat side is provided on a front surface of the valve body substrate, and
a weight is fixed to the valve body substrate by positioning with the positioning recess.

31. The muffler valve according to claim 12, wherein
the valve seat substrate is provided with a welding region protruding outward from an outer peripheral edge of the valve body substrate on the support shaft side and a side opposite to the support shaft.

32. A muffler in which the valve seat substrate of the muffler valve according to claim 12 is fixed to a peripheral edge of an opening of a separator that partitions the inside of the muffler.
